(19) United States
(12) Patent Application Publication
(10) Pub. No.: US 2025/0085136 A1
(43) Pub. Date: Mar. 13, 2025

(54) METHOD AND DEVICE FOR ESTIMATING REVOLUTIONS OF A BEARING ON AN OBJECT

(71) Applicant: Aktiebolaget SKF, Göteborg (SE)

(72) Inventors: Xiaoyuan MA, Shanghai (CN); Hongwei WU, Shanghai (CN); Xing YI, Shanghai (CN); Bingliang LOU, Shanghai (CN); Liang ZHANG, Zou Cheng (CN)

(21) Appl. No.: 18/826,438

(22) Filed: Sep. 6, 2024

(30) Foreign Application Priority Data
Sep. 13, 2023 (CN) 202311182032.3

(51) Int. Cl. G01C 22/00

(52) U.S. Cl. CPC G01C 22/00

(57) ABSTRACT

A method and associated device for estimating revolutions of a bearing on an object is disclosed. The method includes receiving a plurality of measurement data from a plurality of sensors. Each of the plurality of measurement data has a corresponding time stamp. The method includes determining a total travelled distance of the object based on the plurality of measurement data and determining a travelled distance offset of the bearing. The travelled distance offset of the bearing is a distance that the object has travelled when the bearing is installed on the object. The method includes determining the revolutions of the bearing based on the determined total travelled distance of the object and the determined travelled distance offset of the bearing.

### CROSS-REFERENCE TO RELATED APPLICATION

This application claims priority to Chinese Application No. 202311182032.3, filed Sep. 13, 2023, the entirety of which is hereby incorporated by reference.

### FIELD

Embodiments of the present disclosure relate to a technical field of data processing, and more specifically, to a method and a device for estimating revolutions of a bearing on an object.

### BACKGROUND

To comprehensively profile the usage of wheel bearings of an object (such as a train, a metro, a vehicle, etc.) or realize trustworthy remote diagnosis of the bearings, recording revolutions of the bearings (that is, the accumulated revolutions since the installation of the bearings) is a very key input. In order to measure such an accumulated metric, continuous monitoring is required generally. However, an energy-constrained (e.g., battery-powered) IoT sensor (e.g., vibration and temperature sensors) generally only wakes up and performs a measurement for few times per day, thereby saving energy consumption. This means that it is difficult for such an energy-constrained sensor to be always-on to record revolutions. Therefore, there is a need for an effective method in which energy-constrained sensors can be used to speculate or estimate the revolutions of a bearing on an object.

### SUMMARY

The SUMMARY section is provided to introduce concepts in a brief form, which will be described in detail in the DETAILED DESCRIPTION section below. The SUMMARY section is not intended to identify key features or essential features of the claimed technical solutions, nor is it intended to limit the scope of the claimed technical solutions.

Embodiments of the present disclosure provide a method for estimating revolutions of a bearing on an object, which includes: receiving a plurality of measurement data from a plurality of sensors, wherein each of the plurality of measurement data has a corresponding time stamp; determining a total travelled distance of the object based on the plurality of measurement data; determining a travelled distance offset of the bearing, wherein the travelled distance offset of the bearing is a distance that the object has travelled when the bearing is installed on the object; and determining the revolutions of the bearing based on the determined total travelled distance of the object and the determined travelled distance offset of the bearing.

According to embodiments of the present disclosure, each of the plurality of sensors is an energy-constrained sensor, and wherein the plurality of measurement data is measured by the plurality of sensors waking up sequentially according to a preset order and a preset time interval for measuring the measurement data.

According to embodiments of the present disclosure, each of the plurality of sensors is an energy-constrained sensor, wherein the plurality of measurement data is measured by at least one of the plurality of sensors waking up at a wake-up time for a second measurement, and wherein the second measurement is another measurement different from a measurement for the measurement data.

According to embodiments of the present disclosure, each of the plurality of measurement data includes location information of the object, the location information being used for indicating a location of the object when the measurement data is measured, and wherein the determining a total travelled distance of the object based on the plurality of measurement data includes: determining a first incremental travelled distance of the object based on the location information of the object and the corresponding time stamp; and adding the first incremental travelled distance with a previously travelled distance of the object to determine the total travelled distance.

According to embodiments of the present disclosure, each of the plurality of sensors includes a positioning module, and wherein the location information of the object is acquired via the positioning module.

According to embodiments of the present disclosure, each of the plurality of measurement data includes running status information of the object, the running status information being used for indicating a running status of the object when the measurement data is measured, and wherein the determining a total travelled distance of the object based on the plurality of measurement data includes: determining a running time of the object based on the running status information of the object and the corresponding time stamp; determining a second incremental travelled distance of the object based on the running time and a running speed corresponding to the running time; and adding the second incremental travelled distance with a previously travelled distance of the object to determine the total travelled distance.

According to embodiments of the present disclosure, each of the plurality of sensors includes a speed acquisition module, and wherein the running status information of the object is acquired via the speed acquisition module.

According to embodiments of the present disclosure, the running status of the object includes one or more of the following: a fast-running status, a slow-running status and a stopping status.

According to embodiments of the present disclosure, the determining the revolutions of the bearing based on the determined total travelled distance of the object and the determined travelled distance offset of the bearing includes: subtracting the travelled distance offset from the total travelled distance to obtain a first travelled distance of the bearing; and dividing the first travelled distance by a second travelled distance associated with the bearing to obtain the revolutions, wherein the second travelled distance is a distance travelled by the object when the bearing rotates a turn.

Embodiments of the present disclosure provide a device for estimating revolutions of a bearing on an object, which includes: a transceiver configured to receive a plurality of measurement data from a plurality of sensors, wherein each of the plurality of measurement data has a corresponding time stamp; and a processor coupled to the transceiver and configured to determine a total travelled distance of the object based on the plurality of measurement data; determine a travelled distance offset of the bearing, wherein the travelled distance offset of the bearing is a distance that the object has travelled when the bearing is installed on the object; and determine the revolutions of the bearing based on the determined total travelled distance of the object and the determined travelled distance offset of the bearing.

Embodiments of the present disclosure provide an apparatus for estimating revolutions of a bearing on an object, which includes: a communication module configured to receive a plurality of measurement data from a plurality of sensors, wherein each of the plurality of measurement data has a corresponding time stamp; a first determination module configured to determine a total travelled distance of the object based on the plurality of measurement data; a second determination module configured to determine a travelled distance offset of the bearing, wherein the travelled distance offset of the bearing is a distance that the object has travelled when the bearing is installed on the object; and a third determination module configured to determine the revolutions of the bearing based on the determined total travelled distance of the object and the determined travelled distance offset of the bearing.

Embodiments of the present disclosure provide a computer-readable storage medium having stored thereon instructions that, when executed, cause a processor to perform a method for estimating revolutions of a bearing on an object according to embodiments of the present disclosure.

The method, device and apparatus provided by the present disclosure have at least one or more of the following advantages: 1) by exploiting distributed energy-constrained sensors (rather than relying on any wire-powered always-on devices), the revolutions of a wheel bearing can be speculated, and 2) by using the method provided by the present disclosure, the track of the object equipped with the sensors also can be potentially profiled.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic, and the original and elements are not necessarily drawn to scale.

FIG. 1 shows a schematic diagram of determining a travelled distance of an object based on location information received from a plurality of sensors according to embodiments of the present disclosure;

FIG. 2 shows a schematic diagram of revising a distance by exploiting a GIS method according to embodiments of the present disclosure;

FIG. 3 shows a schematic diagram of determining a travelled distance of an object based on running status information received from a plurality of sensors according to embodiments of the present disclosure;

FIG. 4 shows a schematic diagram of a method for estimating revolutions of a bearing on an object according to embodiments of the present disclosure;

FIG. 5 shows an example flow of a method for estimating revolutions of a bearing on an object performed on a computing device according to embodiments of the present disclosure;

FIG. 6 shows a schematic diagram of a device for estimating revolutions of a bearing on an object according to embodiments of the present disclosure; and

FIG. 7 shows a schematic diagram of an apparatus for estimating revolutions of a bearing on an object according to embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementations of the present disclosure may be performed in a different order and/or in parallel. Furthermore, method implementations may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of some other terms will be given in the following description.

It should be noted that the concepts of “first” and “second” mentioned in the present disclosure are only used to distinguish different means, modules or units, and are not used to limit the order or interdependence of the functions performed by these means, modules or units.

It should be noted that the modifications of “a” and “a plurality” mentioned in the present disclosure are schematic but not limiting, and those skilled in the art should understand that unless the context clearly indicates otherwise, they should be understood as “one or more”.

Names of messages or information exchanged among multiple apparatuses in the implementations of the present disclosure are only used for illustrative purposes, and are not used to limit the scope of these messages or information.

In the present disclosure, an object may refer to any object that travels through wheels and is equipped with wheel bearings, such as a train, a metro, a vehicle (a car, a truck, etc.), a bicycle, etc.

In the present disclosure, an energy-constrained sensor may refer to a sensor that wakes up and performs measurement only once or a few times in a certain time period in order to save energy consumption, for example, a battery-powered sensor.

In order to realize trustworthy remote diagnosis of bearings by sensors (for example, vibration and temperature sensors), as one of the most commonly used inputs, accumulated revolutions since the installation of the bearings is expected to be provided. In order to measure such an accumulated metric, continuous monitoring is required generally, which is a great challenge for energy-constrained (e.g., battery-powered) Internet of Things (IoT) sensors to be always-on.

The present disclosure provides a method for speculating revolutions of a wheel bearing by using a plurality of energy-constrained sensors installed in an object. The method may be realized by using a computing device and a group of energy-constrained sensors. The sensors wake up sequentially or one after another, measure measurement data of the object (for example, location or running status, etc.) and record corresponding time stamps, and upload the measurement data to the computing device (for example, a server, a cloud server or a gateway, etc.). Then, the computing device may speculate a distance travelled by the object equipped with these sensors. Based on this, revolutions of wheel bearings can be further estimated or speculated.

In some embodiments, a sensor installed in an object (e.g., a train or metro, etc.) can provide location information of the object and/or sense the running status of the object (e.g., fast-running, slow-running or stopping, etc.). Generally, the location information of the object may be obtained via a positioning module (for example, a Global Position System (GPS)/Global Navigation Satellite System (GNSS) module), and the running status of the object may be sensed via a speed acquisition module. In some embodiments, the speed acquisition module may be an accelerometer module, a gyroscope, and any other existing or future module that can be applied to sense the speed of an object. In some embodiments, the speed acquisition module may also be a receiving module capable of receiving external information input (for example, speed information of the object, etc.) from the outside or other modules. In order to simplify the description, an accelerometer module will be described below as an example. In some embodiments, the location information and/or running status of the object may be obtained through a plurality of sensors (for example, temperature sensors or vibration sensors) already equipped on the object currently. For example, an existing (or associated) positioning module and/or accelerometer module in a plurality of sensors already equipped on the object currently can be used to obtain the location information and/or running status of the object, or a positioning module and/or accelerometer module may be integrated in a plurality of sensors already equipped on the object currently to obtain the location information and/or running status of the object. In addition, the location information and/or running status of the object can also be obtained through a specific sensor including a positioning module and/or an accelerometer module. In some cases, these sensors may be energy-constrained sensors.

In some embodiments, all (e.g., N, where N is an integer greater than or equal to 2) energy-constrained sensors may wake up sequentially or one after another. In some embodiments, N sensors may wake up sequentially according to a preset number, order and/or time interval in turn. In some embodiments, one or more of the N sensors may also wake up and perform measurement according to their own states. For example, when a sensor detects that its power is lower than a first threshold, the sensor may choose to wake up again every other round, and so on. After waking up, the sensor can measure the location information and/or running status of the object, while recording a time stamp corresponding to the measurement. A plurality of measurement data (e.g., location information and/or running status with a time stamp) may be uploaded to a computing device (e.g., a server, a cloud server or a gateway, etc.). In some embodiments, the measurement data may be uploaded at a pre-configured time point. In some embodiments, measurement data may be uploaded based on a request or trigger of the computing device. In some embodiments, the measurement data may be uploaded together with other data (e.g., temperature data, vibration data, etc.).

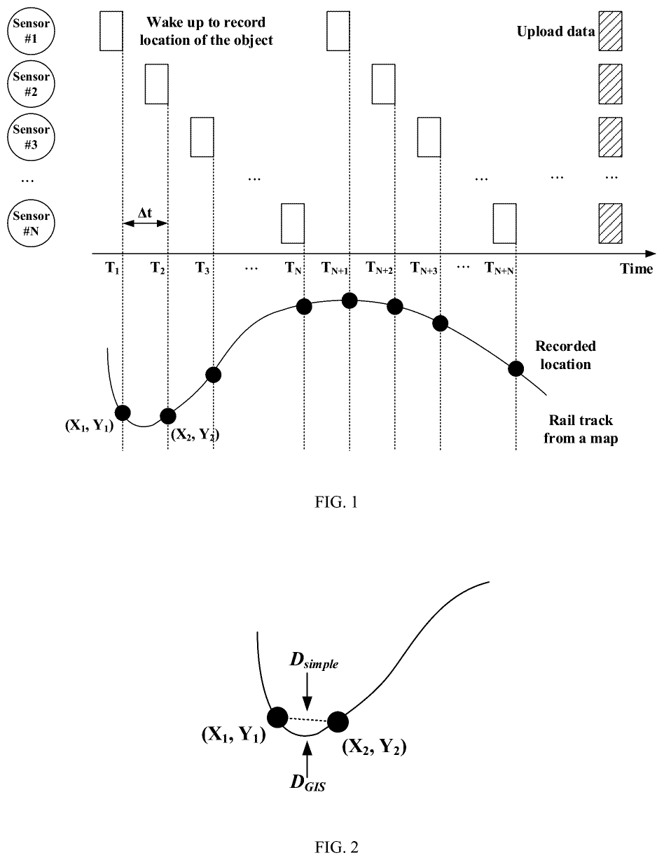

FIG. 1 shows a schematic diagram of determining a travelled distance of an object based on location information received from a plurality of sensors according to embodiments of the present disclosure. For an application (for example, a train application) where location information can be easily available, as shown in FIG. 1, location information (for example, object locations recorded at times T_{I}, T₂, . . . , T_{N+N}) recorded by multiple (for example, N) sensors may be plotted in a cloud server. The distance between two location samples (for example, the distance between location samples at T₁ and T₂) may be simply estimated by \sqrt{(X₁−X₂)²+(Y₁−Y₂)²}, where X and Y (i.e., X₁, Y₁, X₂, Y₂) represent location coordinates of the object (e.g., latitude and longitude). To simplify the issue, a more specific process of conversion of latitude and longitude location coordinates to the distance is omitted here. If more accuracy is expected, a time interval Δt between adjacent sample time points (for example, the time interval between T₁ and T₂) can be shortened or the distance can be revised by exploiting a Geographic Information System (GIS) method.

For example, FIG. 2 shows a schematic diagram of revising a distance by exploiting a GIS method according to embodiments of the present disclosure. As shown in FIG. 2, a rail line corresponding to two adjacent location samples can be selected on a specific map and the length distance of the two adjacent location samples on the rail line can be calculated. The distance simply estimated based on the above equation may be expressed as Dₛᵢₘₚₗₑ=\sqrt{(X₁−X₂)²+(Y₁−Y₂)²}, while the distance further revised based on the GIS method as shown in FIG. 2 may be expressed as D_{GIS}(X₁, Y₁, X₂, Y₂). Furthermore, based on the distance between every two adjacent location samples, by the addition thereof, the distance travelled by the object in any time period or between any two location samples can be calculated.

In this way, by using N sensors installed in the object, a location sample rate of 1/Δt can be realized, while each sensor is only required to wake up at a rate of

$$\frac{1}{Δ t \times N} ,$$

thereby reducing the energy consumption significantly. It should be noted that the time interval Δt does not need to be a constant, because each measurement data has a corresponding time stamp, which means that, especially for a greater N, one or more of the N sensors may even wake up and perform measurement according to their own scheduling instead of in a dedicated manner. For example, in the case that the sensors are temperature or vibration sensors integrated with (or associated with) positioning modules and/or accelerometer modules as described above, one or more of the N sensors may wake up and perform measurement of the location and/or running status of the object according to a scheduling for other measurements (which may be referred to as a second measurement herein) other than the measurement of the location and/or running status, without specially configuring a wake-up time for the measurement of the location and/or running status of the object. For example, the sensor may wake up at a wake-up time for measuring temperature and/or vibration information, and complete the measurement of the location and/or running status of the object during this time. In some embodiments, the time interval Δt between different adjacent location samples may be the same or different.

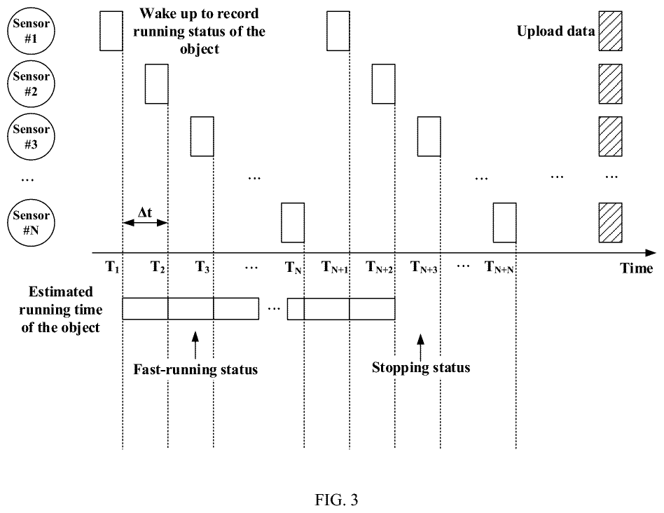

FIG. 3 shows a schematic diagram of determining a travelled distance of an object based on running status information received from a plurality of sensors according to embodiments of the present disclosure.

For an application (for example, a metro application) where location information cannot be easily available but an average speed can be easily available, as shown in FIG. 3, a running status of an object (for example, a metro) can be measured or recorded. In some embodiments, the running status of the object may include one or more of the following: a fast-running status, a slow-running status or a stopping status. In this way, a running time of the object can be estimated in a computing device based on the running status information of the object and the corresponding time stamps, and the distance travelled by the object can be estimated by multiplying the running time by corresponding average speeds. In some embodiments, a corresponding average speed may be estimated or configured in advance for each running status of the object. For example, a fast-running status may correspond to a first speed, a slow-running status may correspond to a second speed lower than the first speed, and a stopping status may correspond to a zero speed. In other embodiments, the average speed of the object in different running statuses may be obtained or estimated by any other way, which is not limited herein. FIG. 3 shows only two running statuses, namely, a fast-running status and a stopping status. It may be assumed in the present disclosure that the running status of the object will not change within a time interval Δt. Therefore, in the example of FIG. 3, it can be considered that the object is in a fast-running status during the period from T₁ to T_{N+2}, and in a stopping status during the period from T_{N+2} to T_{N+N}.

In addition, the location information and/or running status of the object recorded by the sensors may be sent or uploaded to the computing device immediately after they are recorded, or may be uploaded uniformly at a preset time as shown by the shaded rectangle in FIG. 1 or FIG. 3. There is no limitation on the specific data uploading time or manner herein.

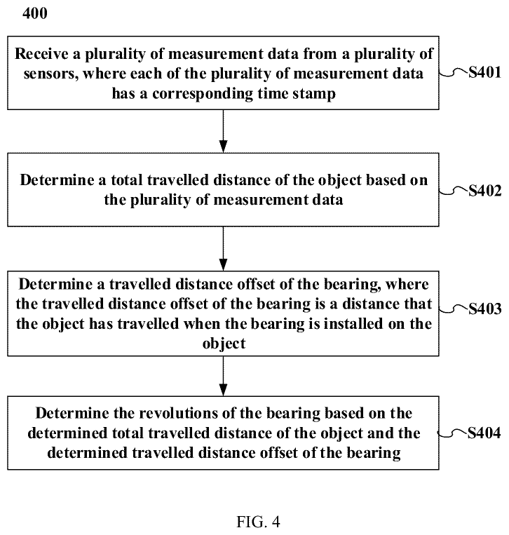

Next, FIG. 4 shows a schematic diagram of a method 400 for estimating revolutions of a bearing on an object according to embodiments of the present disclosure.

As shown in FIG. 4, the method 400 for estimating revolutions of a bearing on an object according to embodiments of the present disclosure may include: in step S401, receiving a plurality of measurement data from a plurality of sensors, where each of the plurality of measurement data has a corresponding time stamp; in step S402, determining a total travelled distance of the object based on the plurality of measurement data; in step S403, determining a travelled distance offset of the bearing, where the travelled distance offset of the bearing is a distance that the object has travelled when the bearing is installed on the object; and in step S404, determining the revolutions of the bearing based on the determined total travelled distance of the object and the determined travelled distance offset of the bearing.

Specifically, in some embodiments, as described above, each of the plurality of sensors may be an energy-constrained sensor. In some embodiments, the plurality of measurement data may be measured by the plurality of sensors waking up sequentially according to a preset order and a preset time interval for measuring measurement data such as the location and/or running status of the object. For example, N sensors may wake up sequentially according to a preset number, order and/or time interval in turn.

In some embodiments, the plurality of measurement data may be measured by at least one of the plurality of sensors waking up at a wake-up time for a second measurement, where the second measurement may be another measurement different from a measurement for the measurement data. For example, in the case that the sensors are temperature or vibration sensors integrated with (or associated with) positioning modules and/or accelerometer modules as described above, one or more of the N sensors may wake up and perform measurement of the location and/or running status of the object according to a scheduling for other measurements (which may be referred to as a second measurement herein) other than the measurement of the location and/or running status. For example, the sensor may wake up at a wake-up time for measuring temperature and/or vibration information, and complete the measurement of the location and/or running status of the object during this time, without specially configuring the wake-up time for the measurement of the location and/or running status of the object, without specially configuring a wake-up time for the measurement of the location and/or running status of the object.

In some embodiments, each of the plurality of measurement data may include location information of an object, which may be used to indicate the location of the object when the measurement data is measured. In some embodiments, the determining a total travelled distance of the object based on the plurality of measurement data in step S402 may further include: determining a first incremental travelled distance of the object based on the location information of the object and the corresponding time stamp; and adding the first incremental travelled distance with a previously travelled distance of the object to determine the total travelled distance.

For example, as shown in FIG. 1, a computing device may receive a plurality of measurement data including location information of an object from sensors and sort the plurality of location information according to corresponding time stamps. The computing device may calculate the distance (for example, segment distance corresponding to each time interval Δt) between two adjacent location samples sorted in a time order through the manners described above, and then accumulate the segment distances corresponding to all time intervals Δt to obtain the first incremental travelled distance travelled by the object in the time period corresponding to the location information. Then, the total travelled distance of the object can be obtained by adding the first incremental travelled distance to the total distance that the object has previously travelled.

In some embodiments, each of the plurality of measurement data may include running status information of the object, which may be used to indicate a running status of the object when the measurement data is measured. In some embodiments, the determining a total travelled distance of the object based on the plurality of measurement data in step S402 may further include: determining a running time of the object based on the running status information of the object and the corresponding time stamp; determining a second incremental travelled distance of the object based on the running time and a running speed corresponding to the running time; and adding the second incremental travelled distance with a previously travelled distance of the object to determine the total travelled distance.

For example, as shown in FIG. 3, a computing device may receive a plurality of measurement data including running status information of the object from the sensors, and sort the plurality of running status information according to corresponding time stamps. As mentioned above, it is assumed that the running status of the object will not change within a time interval Δt, so the running time of the object in each running status can be easily determined based on the plurality of running status information and corresponding time stamps. By multiplying the running time of the object in each running status with a predetermined average speed corresponding to each running status, the second incremental travelled distance travelled by the object in the time period corresponding to these running status information can be determined. Then, the total travelled distance of the object can be obtained by adding the second incremental travelled distance to the total distance that the object has previously travelled.

In some embodiments, the running status of the object may include one or more of the following: a fast-running status, a slow-running status and a stopping status.

In some embodiments, the determining the revolutions of the bearing based on the determined total travelled distance of the object and the determined travelled distance offset of the bearing in step S404 may further include: subtracting the travelled distance offset from the total travelled distance to obtain a first travelled distance of the bearing; and dividing the first travelled distance by a second travelled distance associated with the bearing to obtain the revolutions, where the second travelled distance may be a distance travelled by the object when the bearing rotates a turn. For example, the second travelled distance may be the circumference of a wheel corresponding to the bearing. Furthermore, as described above, the travelled distance offset of the bearing may be the distance that the object has already travelled when the bearing is installed on the object.

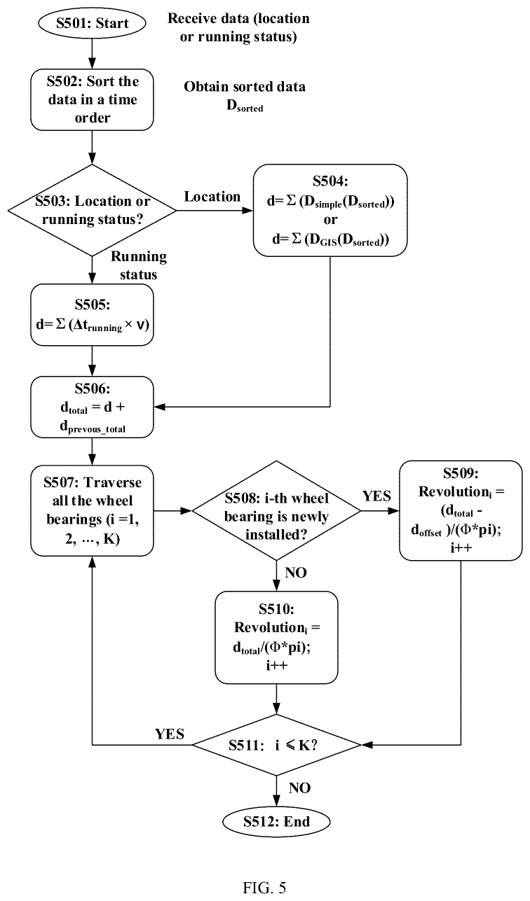

FIG. 5 shows an example flow of a method 500 for estimating revolutions of a bearing on an object performed on a computing device according to embodiments of the present disclosure.

As shown in FIG. 5, the method 500 may start at a step S501, in which a computing device (e.g., a server, a cloud server, etc.) may receive data including location information or running status information of an object from sensors.

In step S502, the received data may be sorted in a time order to obtain sorted data D_{sorted}.

In step S503, it may be determined which information (e.g., location information and/or running status information) is included in the data. If location information is included in the data (for example, in a train application), the method 500 may proceed to step S504. In step S504, a first incremental travelled distance of the object may be calculated in combination with the methods described above. If running status information is included in the data (for example, in a metro application), the method 500 may proceed to step S505. In step S505, a second incremental travelled distance of the object may be calculated in combination with the methods described above.

Then, in step S506, the first incremental travelled distance d determined in step S504 or the second incremental travelled distance d determined in step S505 may be added to the total distance d_{prevous_total} that the object has previously travelled, thereby obtaining the total travelled distance dₜₒₜₐₗ of the object.

Next, in step S507, for an application where there are K wheel bearings (for example, K is an integer greater than or equal to 1), all the wheel bearings may be traversed with operations of steps S508-S511 being performed.

For example, in step S508, it may be determined whether an i-th wheel bearing among the K wheel bearings is newly installed. If the bearing is newly installed, in step S509, a travelled distance offset d_{offset} of the bearing may be subtracted from the total travelled distance dₜₒₜₐₗ of the object, and then the result is divided by the circumference Φ*pi of the wheel corresponding to the bearing (where (represents the diameter of the wheel), so as to determine the revolutions of the bearing, Revolutionᵢ. As described above, the travelled distance offset d_{offset} of the bearing may be the distance that the object has already travelled when the bearing is installed on the object. If the bearing is not newly installed, for example, it was installed before the object started to travel, the method 500 may proceed to step S510. In step S510, the revolutions of the bearing, Revolutionᵢ, may be determined directly by dividing the total travelled distance dₜₒₜₐₗ of the object by the circumference Φ*pi of the wheel corresponding to the bearing.

In step S511, it may be determined whether all the wheel bearings are traversed based on the number i of the current wheel bearing. If not all the wheel bearings have been traversed yet, the method may return to step S507 and steps S508-S511 may be performed again. If all the wheel bearings have been traversed, the method 500 may end in step S512.

It should be understood that the flowchart shown in FIG. 5 is only an example of a method for estimating revolutions of a bearing on an object according to embodiments of the present disclosure, and the steps in FIG. 5 may be performed in any other order. Furthermore, one or more steps in FIG. 5 may be omitted or combined with each other, or any other method or step according to embodiments of the present disclosure may be added thereto.

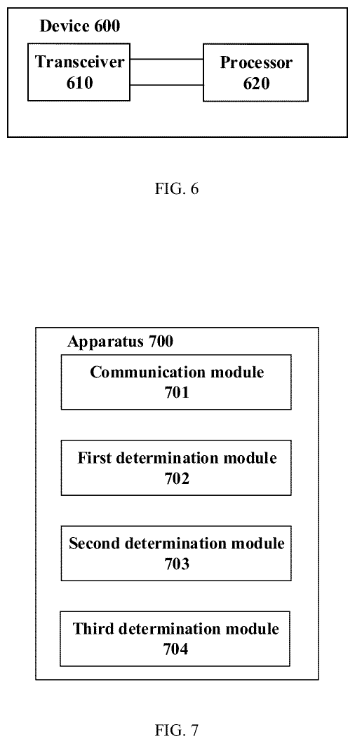

FIG. 6 shows a schematic diagram of a device 600 for estimating revolutions of a bearing on an object according to embodiments of the present disclosure.

The device 600 may be any computing device capable of performing data processing, such as a local server, a cloud server, a data processing center, etc. As shown in FIG. 6, the device 600 may include a transceiver 610 and a processor 620. The transceiver 610 may be configured to receive a plurality of measurement data from a plurality of sensors, where each of the plurality of measurement data has a corresponding time stamp. The processor 620 may be communicatively coupled to the transceiver 610, and may be configured to determine a total travelled distance of the object based on the plurality of measurement data; determine a travelled distance offset of the bearing, where the travelled distance offset of the bearing is a distance that the object has travelled when the bearing is installed on the object; and determine the revolutions of the bearing based on the determined total travelled distance of the object and the determined travelled distance offset of the bearing.

In addition, the device 600 can also perform any other method or step according to the embodiments of the present disclosure as described above, which will not be repeated in detail here.

FIG. 7 shows a schematic diagram of an apparatus 700 for estimating revolutions of a bearing on an object according to embodiments of the present disclosure.

As shown in FIG. 7, the apparatus 700 may include a communication module 701, a first determination module 702, a second determination module 703 and a third determination module 704. The communication module 701 may be configured to receive a plurality of measurement data from a plurality of sensors, where each of the plurality of measurement data has a corresponding time stamp. The first determination module 702 may be configured to determine a total travelled distance of the object based on the plurality of measurement data. The second determination module 703 may be configured to determine a travelled distance offset of the bearing, where the travelled distance offset of the bearing is a distance that the object has travelled when the bearing is installed on the object. The third determination module 704 may be configured to determine the revolutions of the bearing based on the determined total travelled distance of the object and the determined travelled distance offset of the bearing.

In addition, the apparatus 700 may also include other modules that perform any other methods or steps according to the embodiments of the present disclosure as described above, which are not repeated in detail here.

Particularly, according to the embodiments of the present disclosure, the methods or processes described above in connection with the embodiments of the present disclosure or the drawings may be implemented as a computer software program. For example, an embodiment of the present disclosure includes a computer program product including computer programs carried on a non-transitory computer-readable medium, which includes program codes for executing the methods shown in the flowcharts. In such an embodiment, the computer programs may be downloaded and installed from the network through a communication device, or installed from a storage device, or installed from a ROM. When the computer programs are executed by a processing device, the above functions defined in the methods of the embodiments of the present disclosure are performed.

Furthermore, embodiments of the present disclosure provide a computer-readable storage medium having stored thereon instructions that, when executed, cause a processor to perform any method for estimating revolutions of a bearing on an object according to embodiments of the present disclosure.

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions shown in the blocks may occur in a different order other than those shown in the drawings. For example, two blocks shown in succession may actually be executed substantially in parallel, and they may sometimes be executed in a reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or may be implemented by a combination of dedicated hardware and computer instructions.

The units involved in the embodiments described in the present disclosure may be implemented by software or hardware. Herein, the names of the units do not mean a limitation to the units themselves in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store programs for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

The above description is only preferred embodiments of the present disclosure and the explanation of the applied technical principles. It should be understood by those skilled in the art that the disclosure scope involved in the present disclosure is not limited to the technical schemes formed by the specific combination of the above technical features, but also encompasses other technical schemes formed by any combination of the above technical features or their equivalent features without departing from the above disclosure concept, for example, technical schemes formed by replacing the above features with technical features (but not limited thereto) with similar functions disclosed in the present disclosure.

Furthermore, although the operations are depicted in a particular order, this should not be understood as requiring these operations to be performed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical actions, it should be understood that the subject matter defined in the appended claims is not necessarily limited to the specific features or actions described above. On the contrary, the specific features and actions described above are only exemplary forms for implementation of the claims.

What is claimed is:

1. A method for estimating revolutions of a bearing on an object, the method comprising:
receiving a plurality of measurement data from a plurality of sensors, wherein each of the plurality of measurement data has a corresponding time stamp;
determining a total travelled distance of the object based on the plurality of measurement data;
determining a travelled distance offset of the bearing, wherein the travelled distance offset of the bearing is a distance that the object has travelled when the bearing is installed on the object; and
determining the revolutions of the bearing based on the determined total travelled distance of the object and the determined travelled distance offset of the bearing.

2. The method according to claim 1, wherein each of the plurality of sensors is an energy-constrained sensor, and wherein the plurality of measurement data is measured by the plurality of sensors waking up sequentially according to a preset order and a preset time interval for measuring the measurement data.

3. The method according to claim 1, wherein each of the plurality of sensors is an energy-constrained sensor, wherein the plurality of measurement data is measured by at least one of the plurality of sensors waking up at a wake-up time for a second measurement, and
wherein the second measurement is another measurement different from a measurement for the measurement data.

4. The method according to claim 1, wherein each of the plurality of measurement data comprises location information of the object, the location information being used for indicating a location of the object when the measurement data is measured, and
wherein the determining a total travelled distance of the object based on the plurality of measurement data comprises:
determining a first incremental travelled distance of the object based on the location information of the object and the corresponding time stamp; and
adding the first incremental travelled distance with a previously travelled distance of the object to determine the total travelled distance.

5. The method according to claim 4, wherein each of the plurality of sensors comprises a positioning module, and wherein the location information of the object is acquired via the positioning module.

6. The method according to claim 1, wherein each of the plurality of measurement data comprises running status information of the object, the running status information being used for indicating a running status of the object when the measurement data is measured, and
wherein the determining a total travelled distance of the object based on the plurality of measurement data comprises:
determining a running time of the object based on the running status information of the object and the corresponding time stamp;
determining a second incremental travelled distance of the object based on the running time and a running speed corresponding to the running time; and
adding the second incremental travelled distance with a previously travelled distance of the object to determine the total travelled distance.

7. The method according to claim 6, wherein each of the plurality of sensors comprises a speed acquisition module, and wherein the running status information of the object is acquired via the speed acquisition module.

8. The method according to claim 6, wherein the running status of the object comprises one or more of the following: a fast-running status, a slow-running status and a stopping status.

9. The method according to claim 1, wherein the determining the revolutions of the bearing based on the determined total travelled distance of the object and the determined travelled distance offset of the bearing comprises:
subtracting the travelled distance offset from the total travelled distance to obtain a first travelled distance of the bearing; and
dividing the first travelled distance by a second travelled distance associated with the bearing to obtain the revolutions,
wherein the second travelled distance is a distance travelled by the object when the bearing rotates a turn.

10. A device for estimating revolutions of a bearing on an object, the device comprising:
a transceiver configured to:
receive a plurality of measurement data from a plurality of sensors, wherein each of the plurality of measurement data has a corresponding time stamp; and
a processor coupled to the transceiver and configured to:
determine a total travelled distance of the object based on the plurality of measurement data;
determine a travelled distance offset of the bearing, wherein the travelled distance offset of the bearing is a distance that the object has travelled when the bearing is installed on the object; and
determine the revolutions of the bearing based on the determined total travelled distance of the object and the determined travelled distance offset of the bearing.
